(19) United States
(12) Patent Application Publication
(10) Pub. No.: US 2009/0001299 A1
(43) Pub. Date: Jan. 1, 2009

(54) PCV valve

(75) Inventors: Hiroshi Asanuma, Chita-shi (JP); Katsumi Ishida, Toyoake-shi (JP); Koichi Suzuki, Obu-shi (JP); Hirokazu Konohara, Inazawa-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 12/153,334

(22) Filed: May 16, 2008

(30) Foreign Application Priority Data
Jun. 26, 2007 (JP) 2007-167350
Dec. 6, 2007 (JP) 2007-315508
Apr. 24, 2008 (JP) 2008-113384

(51) Int. Cl. F16K 15/00

(52) U.S. Cl. 251/1.3

(57) ABSTRACT

A PCV valve comprises: a valve seat; a valve element provided movable relative to the valve seat; a step motor for moving the valve element; and a housing which houses the valve seat, the valve element, and the step motor. The PCV valve is arranged to operate the step motor by energization to move the valve element with respect to the valve seat so that an area of a blowby gas passage formed between the valve seat and the valve element is changed. An output shaft of the step motor is a member having a higher thermal conductivity than the housing. The step motor, the valve element, and the valve seat are enclosed in a cylindrical case. The step motor and the valve seat are placed in contact with the case.

### BACKGROUND OF THE INVENTION

1. Field of the Invention

The present invention relates to a blowby gas returning device arranged to return blowby gas leaking from a combustion chamber of an engine into a crank case to the combustion chamber by allowing the blowby gas to flow in an intake system of the engine again, and more particularly to a positive crankcase ventilation (PCV) valve installed in the returning device.

2. Description of Related Art

Heretofore, as some techniques of this type, for example JP8-338222 (1996)A and JP53-118640 (1978)A disclose PCV valves arranged to control an open/close position of a valve element according to an engine operating state. The PCV valve disclosed in JP8-338222 (1996)A is arranged such that a cylindrical valve element having a cone-shaped distal end is placed to be movable in an axial direction to change the area of a blowby gas flow passage depending on the position of the valve element relative to a valve seat. This valve element is connected at its proximal end to a shaft whose end is attached with a columnar plunger made of ferromagnetic metal. A coil is placed around an outer periphery of this plunger with clearance therebetween. This coil is energized under control of a controller according to an engine operating state. Accordingly, the plunger is moved by an electromagnetic force of the coil, moving the valve element in the axial direction, thereby changing the blowby gas flow passage area between the valve element and the valve seat. JP53-118640 (1978)A discloses a PCV valve similar to the PCV valve of JP8-338222 (1996)A.

Further, JP61-122313 (1986)U and JP60-98709 (1985)U disclose PCV valves each comprising a valve case internally including a valve chamber and an electric heater serving as a special heating means disposed on an outer periphery of the valve case. This electric heater is to heat the valve element and the valve seat which are placed in the valve chamber.

However, the PCV valves disclosed in JP'222A and JP'640A have disadvantages that water or moisture contained in the blowby gas may freeze in the blowby gas passage. A dispensing section between the valve element and the valve seat is narrow in flow passage area and hence the valve element would be liable to stick to the valve seat due to freezing. On the other hand, the PCV valves disclosed in JP'313U and JP'709U could unfreeze the valve element by the electric heater energized to generate heat, but the configuration of each PCV valve would be complicated due to the addition of the electric heater.

### SUMMARY OF THE INVENTION

The present invention has been made in view of the above circumstances and has an object to provide a PCV valve capable of releasing a valve seat and a valve element from a frozen state without providing an additional special heating means.

To achieve the purpose of the invention, there is provided a PCV valve comprising: a valve seat; a valve element provided movable relative to the valve seat; an electric device for moving the valve element; and a housing which houses the valve seat, the valve element, and the electric device; the PCV valve being arranged to operate the electric device by energization to move the valve element with respect to the valve seat so that an area of a blowby gas passage formed between the valve seat and the valve element is changed, wherein the PCV valve includes a member having a higher thermal conductivity than the housing, and the member is placed in the housing to cover at least the electric device and the valve seat.

According to another aspect, the invention provides a PCV valve comprising: a valve seat; a valve element provided movable relative to the valve seat; an electric device for moving the valve element; and a housing which houses the valve seat, the valve element, and the electric device; the PCV valve being arranged to operate the electric device by energization to move the valve element with respect to the valve seat so that an area of a blowby gas passage formed between the valve seat and the valve element is changed, wherein the PCV valve includes a member having a higher thermal conductivity than the housing, and the electric device and at least one of the valve seat and the valve element are thermally connected to each other through the member having a higher thermal conductivity than the housing.

Further, according to another aspect, the invention provides a PCV valve comprising: a valve seat; a valve element provided movable relative to the valve seat; an electric device for moving the valve element; and a housing which houses the valve seat, the valve element, and the electric device; the PCV valve being arranged to operate the electric device by energization to move the valve element with respect to the valve seat so that an area of a blowby gas passage formed between the valve seat and the valve element is changed, wherein the PCV valve includes a cover having a higher thermal conductivity than the housing, the cover is placed in the blowby gas passage to cover the valve element, and one end of the cover is thermally connected to the electric device, and the valve seat is integrally formed with the cover.

Further, according to another aspect, the invention provides a PCV valve comprising: a valve seat; a valve element provided movable relative to the valve seat; an electric device for moving the valve element; and a housing which houses the valve seat, the valve element, and the electric device; the PCV valve being arranged to operate the electric device by energization to move the valve element with respect to the valve seat so that an area of a blowby gas passage formed between the valve seat and the valve element is changed, wherein the PCV valve includes a cover having a higher thermal conductivity than the housing, the cover is placed in the blowby gas passage to cover the valve element, and one end of the cover is thermally connected to the electric device, the PCV valve further includes a metal elastic member mounted between the valve seat and the cover to press the cover against the electric device.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a PCV valve of a first embodiment;

FIG. 2 is a time chart showing a vehicle driving pattern and others for evaluation of unfreezing in the first embodiment;

FIG. 3 is a time chart showing test results of the evaluation of unfreezing in the first embodiment;

FIG. 4 is a sectional view of a PCV valve of a second embodiment;

FIG. 5 is a sectional view of a PCV valve of a third embodiment;

FIG. 6 is a perspective view of a cover of the third embodiment;

FIG. 7 is an enlarged sectional view of a part S1 circled with a dotted line in FIG. 5, in the PCV valve of the third embodiment;

FIG. 8 is a sectional view of a PCV valve of a fourth embodiment;

FIG. 9 is a sectional view of a PCV valve of another modified example;

FIG. 10 is a sectional view of a PCV valve of another modified example;

FIG. 11 is a sectional view of a PCV valve of another modified example; and

FIG. 12 is a sectional view of a PCV valve of another modified example.

### DETAILED DESCRIPTION OF THE PREFERRED EMBODIMENTS

### First Embodiment

A detailed description of a first preferred embodiment of a PCV valve embodying the present invention will now be given referring to the accompanying drawings.

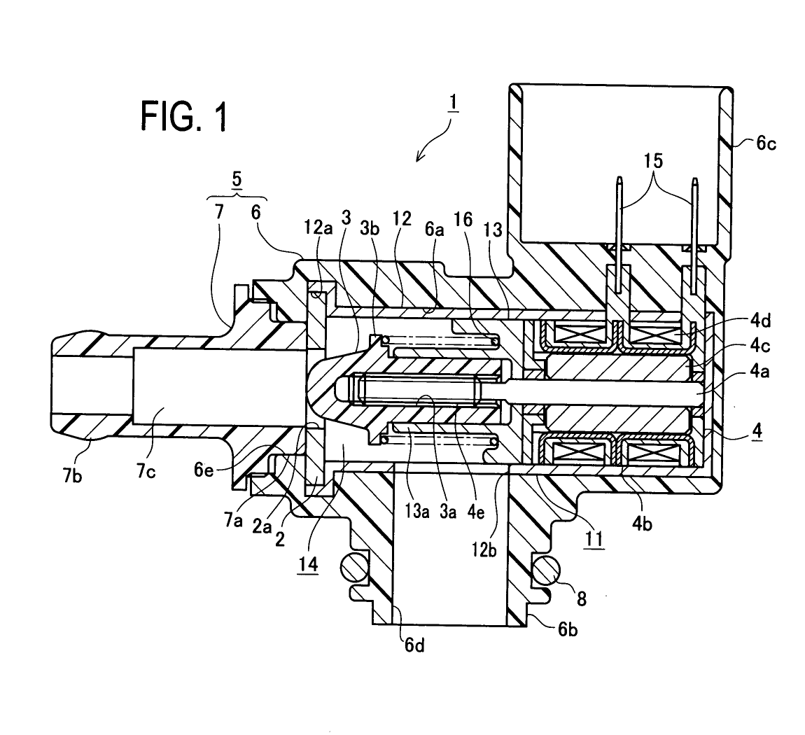

FIG. 1 is a sectional view of a PCV valve 1 of the present embodiment. As well known, this PCV valve 1 is installed in a blowby gas returning device arranged to return blowby gas leaking from a combustion chamber of an engine into a crank case to the combustion chamber by allowing the blowby gas to flow in an intake passage of the engine again. As shown in FIG. 1, this PCV valve 1 mainly includes a valve seat 2, a valve element 3 movable relative to the valve seat 2, a step motor 4 serving as an electric device of the invention for moving the valve element 3, and a housing 5 which houses the valve seat 2, the valve element 3, and the step motor 4. The step motor 4 is energized to move the valve element 3 relative to the valve seat 2, thereby changing an area, namely, an “opening degree” of a blowby gas passage between the valve seat 2 and the valve element 3 to regulate a flow rate of blowby gas to be dispensed by the PCV valve 1. This PCV valve 1 is arranged to operate the valve element 3 by use of the step motor 4. No additional special heating means such as an electric heater is provided to release the valve seat 2 and the valve element 3 from a frozen state. The configuration of the PCV valve 1 will be described below in detail.

In the present embodiment, the housing 5 has a hollow shape and constituted by a main housing 6 and a sub housing 7 which are assembled together. The main housing 6 includes a hollow 6a internally formed, an inlet-side pipe joint 6b formed as a lower part, and a connector 6c formed as an upper part. The inlet-side pipe joint 6b includes an inlet passage 6d communicated with the hollow 6a and is surrounded by a sealing member 8 fitted on the outer periphery. The sub housing 7 is assembled with the main housing 6 in such a way that a proximal end portion 7a is pressure-fitted in a mounting hole 6e formed in a distal end of the main housing 6 and ultrasonic-welded thereto. A distal end portion of the sub housing 7 is formed as an outlet-side pipe joint 7b. The inlet-side pipe joint 6b of the main housing 6 can be engaged in a mounting hole of an engine body or others. The outlet-side pipe joint 7b of the sub housing 7 is connected to one end of a returning passage (pipe) communicated with an intake passage of the engine.

In the hollow 6a of the main housing 6, a valve assembly 11 is integrally provided. This valve assembly 11 is constituted by a bottom-closed cylindrical case 12, the step motor 4 accommodated in the bottom of the case 12, a partition wall member 13 that covers one end surface of the step motor 4, the valve element 3 placed to be movable with respect to the partition wall member 13 and drivingly connected to an output shaft 4a of the step motor 4, and the valve seat 2 mounted in an opening 12a of the case 12 in correspondence with the valve element 3. A space between the valve seat 2 and the partition wall member 13 forms a valve chamber 14 housing the valve element 3.

In this valve assembly 11, as mentioned above, the step motor 4, the partition wall member 13, the valve element 3, and the valve seat 2 are enclosed with the case 12. Further, the step motor 4 and the valve seat 2 are respectively placed in contact with the case 12. The case 12 in the present embodiment is a member having a higher thermal conductivity than the main housing 6. In the present embodiment, specifically, the main housing 6 is made of resin while the case 12 is made of metal such as aluminum. Accordingly, the case 12 which is the higher thermal conductivity member than the main housing 6 constitutes the wall surface of the valve chamber 14 forming part of the blowby gas passage. In addition, the valve element 3 is made of resin and the valve seat 2 is made of metal such as aluminum.

The step motor 4 includes a stator 4b forming an outer periphery part, a rotor 4c placed inside the stator 4b, and the output shaft 4a arranged through the center of the rotor 4c. The stator 4b includes coils 4d and is provided with external terminals 15. Each external terminal 15 is arranged with its distal end portion protruding in the connector 6c. The outer periphery of the stator 4b is in contact with the inner wall of the case 12. The valve element 3 has a nearly cylindrical shape with a protruding round distal end portion. The partition wall member 13 has a sleeve 13a protruding from the center thereof. In the sleeve 13a, the output shaft 4a of the step motor 4 is inserted and the valve element 3 is partially inserted so that the valve element 3 is connected to the output shaft 4a. To be concrete, an externally threaded screw 4e formed on the outer periphery of the output shaft 4a is engaged in an internally threaded hole 3a formed in the valve element 3 to drivingly connect the valve element 3 and the output shaft 4a. When the output shaft 4a is rotated in this state, the valve element 3 is moved in its axial direction because of the threaded relationship between the screw 4e and the threaded hole 3a. The movement direction of the valve element 3 is determined depending on a difference in rotation direction (normal rotation/reverse rotation) of the output shaft 4a. The valve element 3 is formed with a flange 3b radially outwardly extending from the outer periphery of the distal end portion. Between this flange 3b and the partition wall member 13, a compression spring 16 is mounted. The valve element 3 is thus urged toward the valve seat 2 by the spring 16. The valve seat 2 has an annular shape having a center valve hole 2a. The valve element 3 is arranged so that it distal end portion is moved in/out the valve hole 2a of the valve seat 2. The distal end portion of the valve element 3 is tapered externally so that the diameter thereof gradually decreases toward a distal end. Accordingly, movement of the valve element 3 in the axial direction changes an area of a clearance between the valve seat 2 and the valve element 3, that is, an area (an opening degree) of the blowby gas passage. The clearance between the valve seat 2 and the valve element 3 is an exit of the valve chamber 14. The sub housing 7 include a hollow 7c communicated with the valve chamber 14 of the main housing 6. Both the valve chamber 14 and the hollow 7c constitute part of the blowby gas passage. The case 12 is formed with an opening 12b communicated with the inlet passage 6d.

In the present embodiment, the valve assembly 11 is insert-molded in the main housing 6. Specifically, during resin molding of the main housing 6, the valve assembly 11 is set as an insert member in a mold and then molten resin is injected in the mold. The molten resin is solidified with the valve assembly 11 enclosed therein. Thus, the main housing 6 is produced as an integral compound component.

The connector 6c of the main housing 6 is connected to an external connector (not shown). The external connector is electrically connected to the external terminals 15. The external connector is also connected to a controller (not shown) via an external wire (not shown) for controlling the step motor 4.

According to the PCV valve 1 of the present embodiment explained as above, during engine operation, intake negative pressure generated in the intake passage acts on the hollow 7c of the sub housing 7 in a state shown in FIG. 1 through the returning passage. On the other hand, the blowby gas filled in a main body of the engine enters the valve chamber 14 through the inlet passage 6d of the inlet-side pipe joint 6b. In the state shown in FIG. 1, a clearance provided between the vas seat 2 and the valve element 3 allows the blowby gas to be sucked by the intake negative pressure from the valve chamber 14 into the hollow 7c of the sub housing 7. At that time, the step motor 4 is energized to operate, moving the valve element 3 relative to the valve seat 2 to change the area of the clearance (the opening degree) between the valve element 3 and the valve seat 2, thereby regulating the flow rate of the blowby gas.

When the step motor 4 is energized to operate to move the valve element 3, the coils 4d of the step motor 4 generate heat upon energization. That is, the step motor 4 generates heat by energization during operation. It is known that the heat generated in the step motor 4 rises up to a temperature of 70° C. to 80° C. The case 12 constituting the valve assembly 11 is the higher thermal conductivity member than the main housing 6. Such case 12 covers the step motor 4, the partition wall member 13, the valve element 3, and the valve seat 2. Further, the step motor 4 and the valve seat 2 are placed in contact with the case 12. Consequently, the heat generated in the coils 4d of the step motor 4 will be conducted more rapidly to the valve seat 2 through the case 12 than to the main housing 6, thus heating the valve seat 2 promptly. In this PCV valve 1, therefore, even the valve seat 2 and the valve element 3 are mutually frozen during a cold period, the heat conducted from the step motor 4 is utilized to unfreeze the valve seat 2 and the valve element 3. In other words, this PCV valve 1 can release the valve seat 2 and the valve element 3 from a frozen state without needing an additional special heating member such as an electric heater. Moreover, even when surroundings around the PCV valve 1 come to a cold condition during engine operation, the valve seat 2 is heated by the heat generated in the step motor 4 while the step motor 4 is operated by energization. Thus, the valve seat 2 and the valve element 3 can be prevented efficiently from becoming frozen.

In the present embodiment, the case 12 with a higher thermal conductivity than the main housing 6 constitutes the wall surface of the valve chamber 14 serving as part of the blowby gas passage. Accordingly, the blowby gas flowing in that passage is warmed by the heat generated from the case 12. The warmed blowby gas contributes to de-icing, thereby more quickly eliminating the freezing of the valve seat 2 and the valve element 3.

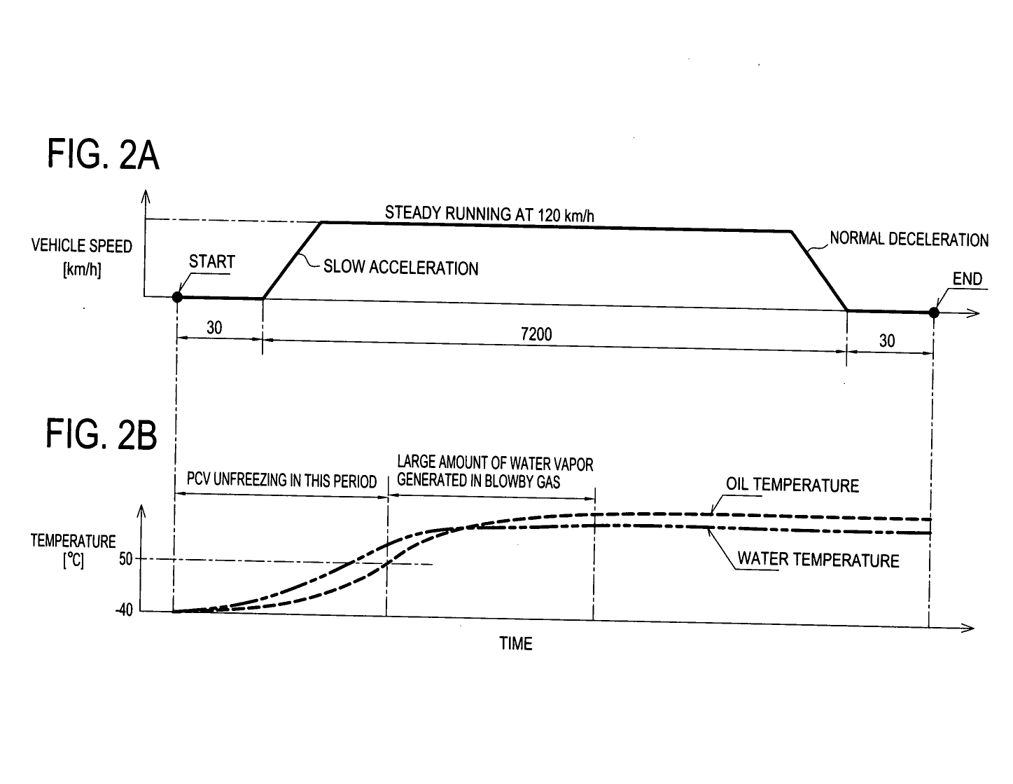

Here, the effectiveness of eliminating the freezing, i.e., unfreezing, by the aforementioned PCV valve 1 will be explained below. FIG. 2 is a time chart showing a vehicle driving pattern and others for evaluation of unfreezing. In FIG. 2, an upper graph A shows changes in vehicle speed and a lower graph B shows changes in engine cooling water temperature (water temperature) and an engine lubricant temperature (oil temperature). As shown in the graph A of FIG. 2, this driving pattern shows that the engine was started from a cold state of “−40° C.”, operated at idle only for “30 seconds” from the startup, and subsequently driven at slow acceleration, at steady driving at 120 kilometers per hour, and at normal deceleration in sequence for “7200 seconds”, and then operated at idle for “30 seconds” and stopped. Meanwhile, the water temperature and the oil temperature gradually rose to a predetermined maximum temperature and changed while keeping the maximum temperature as shown in the graph B of FIG. 2. Here, the oil temperature rose to “50° C.” at an initial stage of the steady driving. When the oil temperature exceeds “50° C.”, water vapor content in the blowby gas increases. This is because water or moisture in the lubricant begins to gradually vaporize when the oil temperature rises to about “50° C.”. If the PCV valve could not be opened due to freezing while the blowby gas contains a large amount of vapor, the blowby gas containing the large amount of water vapor may flow back from the engine to the atmosphere side of the intake passage through a scavenging passage. If the large amount of water vapor flows upstream of the throttle body, the throttle valve may be frozen and stuck to the bore. It is therefore necessary to eliminate the freezing of (to unfreeze) the PCV valve before the oil temperature reaches “50° C.”.

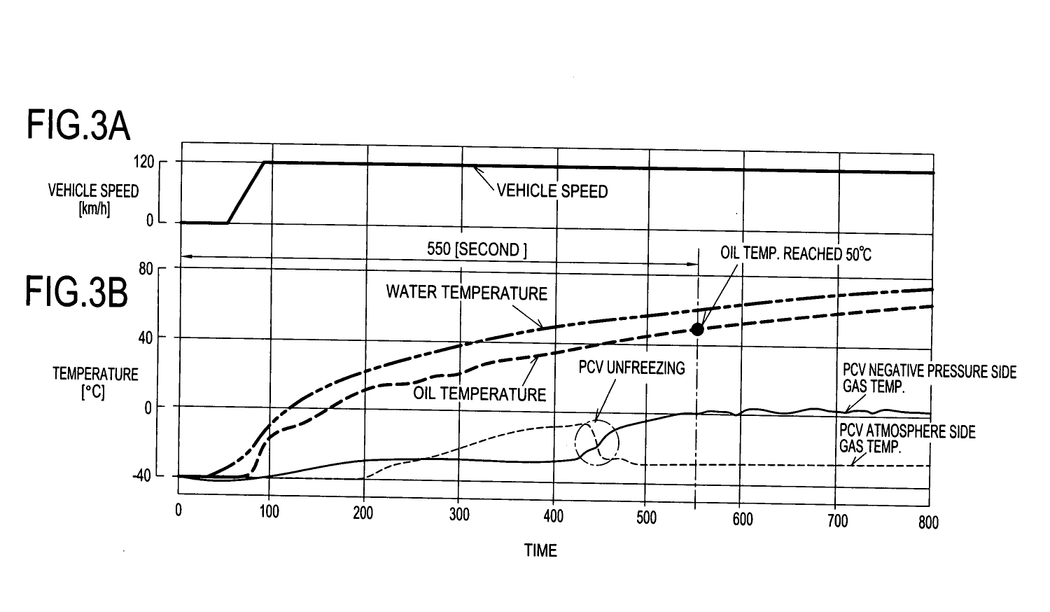

FIG. 3 is a time chart showing test results of the evaluation of unfreezing conducted by use of the PCV valve 1 of the present embodiment and under the same driving pattern as above. In FIG. 3, an upper graph A shows changes in vehicle speed and a lower graph B shows changes in water temperature, oil temperature, PCV negative pressure side gas temperature, and PCV atmosphere side gas temperature. The “PCV negative pressure side gas temperature” represents the gas temperature on the downstream side of the PCV valve 1 and the “PCV atmosphere side gas temperature” represents the gas temperature on the upstream side of the PCV valve 1. As is found from the graph B of FIG. 3, the oil temperature reached “50° C.” after a lapse of “550 seconds” from the engine start. In this test, the energization of the step motor 4 is started to drive the valve element 3 of the PCV valve 1 at the same time as the engine start. The heat generated from the step motor 4 upon start of energization heats the valve seat 2 of the PCV valve 1. Here, it takes a certain time to increase the temperature of the step motor 4, conduct the heat thereof to the valve seat 2 through the case 12 to heat the valve seat 2 until the valve seat 2 and the valve element 3 are released from a frozen state. The graph B of FIG. 3 shows that, after a lapse of “about 450 seconds” from the engine start, the PCV negative pressure side gas temperature and the PCV atmosphere side gas temperature were reversed in level, which is a second reversal. This temperature level reversal timing indicates that the freezing of the PCV valve 1 is eliminated (PCV unfreezing).

This temperature reversal timing indicates the PCV unfreezing timing for the following reason. In the graph B of FIG. 3, the PCV atmosphere side gas temperature is higher than the PCV negative pressure side gas temperature during a period of “about 300 seconds to 420 seconds” because the blowby gas does not flow downstream of the PCV valve 1 and flows back to the atmosphere side passage while the valve seat 2 and the valve element 3 of the PCV valve 1 remain frozen. When the valve seat 2 and the valve element 3 are unfrozen, the blowby gas is allowed to flow downstream of the PCV valve 1 and cold fresh air is introduced into the atmosphere side passage, thus decreasing the PCV atmosphere side gas temperature. On the other hand, during the period of “about 300 seconds to 420 seconds” in the graph B of FIG. 3, the PCV negative pressure side gas temperature is lower than the PCV atmosphere side gas temperature because the blowby gas does not flow downstream of the PCV valve 1 while the valve seat 2 and the valve element 3 of the PCV valve 1 remain frozen, and hence the PCV negative pressure side gas temperature does not rise. When the valve seat 2 and the valve element 3 are unfrozen, the blowby gas is allowed to flow downstream of the PCV valve 1, thus increasing the PCV negative pressure side gas temperature. The aforementioned level reversal of the PCV atmosphere side gas temperature and the PCV negative pressure side gas temperature means this phenomenon, which indirectly indicates the PCV unfreezing.

According to the PCV valve 1 of the present embodiment, the PCV valve 1 can be recovered from the frozen state before the oil temperature reaches “50° C.”. When the PCV valve 1 is installed in the blowby gas returning device, the blowby gas is allowed to flow in the intake passage through the PCV valve 1 before a large amount of vapor is generated as mentioned above. It is therefore possible to prevent the large amount of water vapor from flowing upstream of the throttle body, thereby preventing the throttle valve from becoming frozen due to the large amount of water vapor. In this regard, it is found that the PCV valve 1 of the present embodiment can function efficiently in unfreezing. The PCV valve 1 of the present embodiment requires some time to indirectly heat the valve seat 2, resulting in a slight delay from the heating start up to the removal of freezing, as compared with the conventional PCV valve including an additional special heating means such as an electric heater to actively heat the valve element and the valve seat and others. In the PCV valve 1 of the present embodiment, however, the valve seat 2 and the valve element 3 can be unfrozen in several minutes from the heating start as shown in FIG. 3. The delay in unfreezing will not cause any disadvantages due to the generation of water vapor and the PCV valve 1 can be efficiently placed in an unfrozen state.

### Second Embodiment

Next, a second embodiment of a PCV valve of the invention will be explained in detail referring to the accompanying drawings.

In the second and subsequent embodiments described below, identical components or parts to those in the first embodiment are given the same reference signs and their explanations are omitted. The following explanation will be made with a focus on differences from the first embodiment.

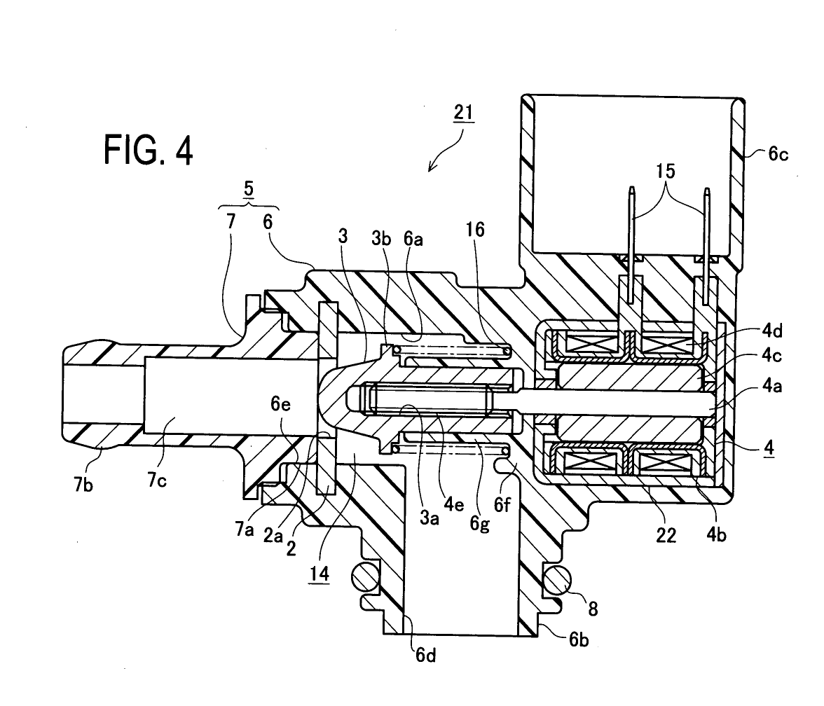

FIG. 4 is a sectional view of a PCV valve 21 of the second embodiment. The PCV valve 21 of the second embodiment differs in the absence of the valve assembly 11 from the PCV valve 1 of the first embodiment. In the present embodiment, specifically, the case 12 of the first embodiment is omitted and the step motor 4 is singly covered by a motor case 22 and integrally insert-molded in the main housing 6. The partition wall member 13 provided in the first embodiment is replaced by a partition wall 6f integrally formed with the main housing 6 in the second embodiment. The valve element 3 is inserted in a sleeve 6g formed protruding from this partition wall 6f. The valve seat 2 is insert-molded in the main housing 6. In the present embodiment, the output shaft 4a of the step motor 4 is made of metal such as aluminum and the valve element 3 connected to the output shaft 4a is also made of metal such as aluminum, which are different in configuration from those in the first embodiment. Accordingly, in the present embodiment, the step motor 4 and the valve element 3 are thermally connected to each other through the output shaft 4a which is a higher thermal conductivity material than the main housing 6. The valve element 3 is made of a higher thermal conductivity material than the main housing 6.

According to the PCV valve 21 of the present embodiment, when the step motor 4 is operated by energization to move the valve element 3, the step motor 4 generates heat upon energization. Here, the step motor 4 and the valve element 3 are thermally connected to each other through the output shaft 4a having a higher thermal conductivity than the main housing 6. Accordingly, the heat generated in the step motor 4 will be conducted more rapidly to the valve element 3 through the output shaft 4a than to the main housing 6, thus heating the valve element 3 promptly. In the present embodiment, therefore, by energization of the step motor 4 to move the valve element 3, the heat of the step motor 4 is utilized to unfreeze the valve seat 2 and the valve element 3 without needing an additional special heating means such as an electric heater.

In the present embodiment, moreover, the valve element 3 is made of a higher thermal conductivity than the main housing 6, so that the heat conducted to the output shaft 4a of the step motor 4 can be conducted to the valve element 3 readily. This makes it possible to heat the valve element 3 rapidly and hence unfreeze the valve seat 2 and the valve element 3 promptly.

### Third Embodiment

Next, a third embodiment of a PCV valve of the invention will be explained in detail referring to the accompanying drawings.

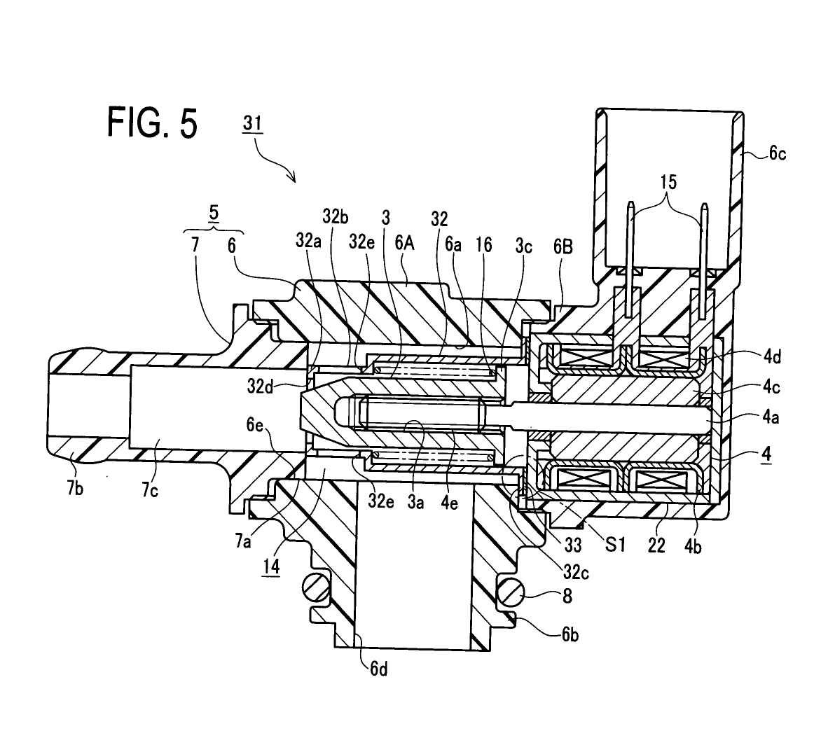

FIG. 5 is a sectional view of a PCV valve 31 of the third embodiment. The PCV valve 31 of the third embodiment firstly differs in the main housing 6 divided into two parts from the PCV valve 21 of the second embodiment. In the present embodiment, specifically, the main housing 6 is constituted by separate parts, i.e., a first main housing 6A including the valve chamber 14 and a second main housing 6B covering the step motor 4. Here, the first main housing 6A has substantially the same configuration as a corresponding part of the main housing 6 of the second embodiment, excepting that the first main housing 6A does not have the partition wall 6f and the sleeve 6g. The second main housing 6B has substantially the same configuration as a corresponding part of the main housing 6 of the second embodiment. The step motor 4 is insert-molded in the second main housing 6B. A distal end of the second main housing 6B integrally configured with the step motor 4 is pressure-fitted in an opening of a proximal end of the first main housing 6A and an outer periphery of the distal end of the second main housing 6B is ultrasonic-welded to the first main housing 6A. The output shaft 4a of the step motor 4 is made of metal such as aluminum and the valve element 3 connected to the output shaft 4a is also made of metal such as aluminum. Thus, in the present embodiment, the step motor 4 and the valve element 3 are thermally connected to each other through the output shaft 4a having a higher thermal conductivity than the main housing 6. The valve element 3 made of metal such as aluminum also has a higher thermal conductivity than the main housing 6.

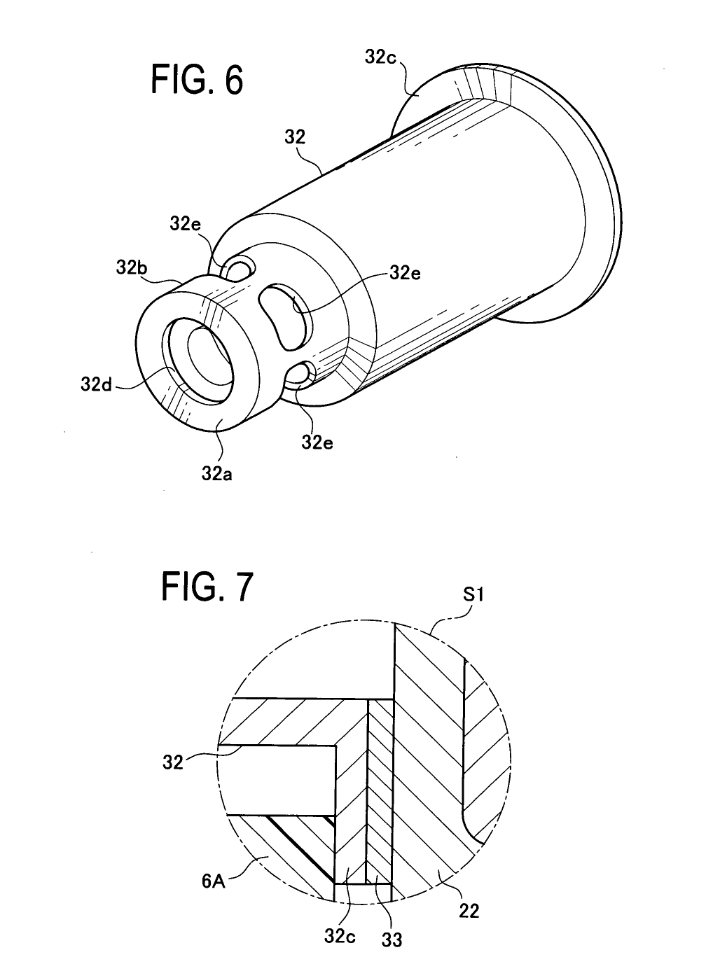

Different from the second embodiment, the PCV valve 31 of the third embodiment includes a cover 32 integrally formed with a valve seat 32a instead of the valve seat 2 of the second embodiment. The cover 32 is placed in the valve chamber 14 to cover the valve element 32. FIG. 6 is a perspective view of the cover 32. This cover 32 is of a nearly cylindrical shape including a small-diameter portion 32b on a distal end side and a flange 32c on a proximal end side. The cover 32 is also made of metal such as aluminum having a higher thermal conductivity than the main housing 6. The small-diameter portion 32b has an end wall serving as the valve seat 32 and a vent hole 32d at the center thereof. The small-diameter portion 32b is formed with a plurality of openings 32e arranged at regular intervals on the periphery. This cover 32 is disposed in the valve chamber 14 to cover the valve element 3 as shown in FIG. 5. Further, the cover 32 is located in such a way that the flange 32c is in contact with the end surface of the motor case 22 of the step motor 4 through a graphite sheet 33. This flange 32c is sandwiched and fixed between the end surface of the motor case 22 and the inner wall of the first main housing 6A. FIG. 7 is an enlarged sectional view of a part S1 circled with a dotted line in FIG. 5. The graphite sheet 33 serves to enhance adhesion between the flange 32c of the cover 32 and the end surface of the motor case 22 and thermally connect the flange 32c and the step motor 14. The graphite sheet 33 corresponds to a heat conduction assist member of the invention for assisting heat conduction between the step motor 14 and the cover 32. In the present embodiment, the valve element 3 is formed at its proximal end with the flange 3c and the compression spring 16 is mounted between the flange 3c and a shoulder portion of the small-diameter portion 32b of the cover 32. The valve element 3 has a truncated-cone-shaped distal end portion which is insertable in the valve hole 32d of the valve seat 32a.

When the step motor 4 is operated by energization to move the valve element 3 relative to the valve seat 32a, consequently, the area of the blowby gas passage between the valve seat 32a and the valve element 3, that is, the “opening degree” is changed to regulate the flow rate of the blowby gas to be dispensed by the PCV valve 31. The blowby gas flowing in the inlet passage 6d of the main housing 6 is allowed to enter the valve chamber 14 and pass through the hole 32e and the clearance between the valve element 3 and the valve seat 32a, and flow in the hollow 7c of the sub housing 7.

According to the PCV valve 31 of the present embodiment as mentioned above, the step motor 4 is operated by energization to move the valve element 3, so that the heat is generated in the step motor 4 by energization. Here, in the valve chamber 14, the valve element 3 is covered by the cover 32 having a higher thermal conductivity than the main housing 6, and the flange 32c of the cover 32 is thermally connected to the end surface of the motor case 22 of the step motor 4. Accordingly, the heat generated in the step motor 4 is conducted to the cover 32 rapidly, so that the valve element 3 is heated promptly by the heat released from the cover 32. Since the valve seat 32a is integrally formed with the cover 32, the valve seat 32a can also be heated rapidly when the cover 32 is heated. Consequently, utilization of the heat generated in the step motor 4 can unfreeze the valve seat 32a and the valve element 3 without needing an additional special heating means such as an electric heater.

In the present embodiment, moreover, the graphite sheet 33 is provided between the end surface of the motor case 22 and the flange 32c of the cover 32. This graphite sheet 33 can enhance heat conduction between the flange 32c and the motor case 22. This makes it possible to promote elimination of the freezing of the valve seat 32a and the valve element 3 from the frozen state and hence shorten the time required for the elimination of the freezing.

In the present embodiment, after warm-up where the freezing has been eliminated, the cover 32 can function as a radiator for the step motor 4. This can promote heat release of the step motor 4 to prevent the temperature of the step motor 4 from rising, thereby restraining a torque decrease. As compared with a case where the cover 32 is not used, the step motor 4 can be achieved in compact size for producing desired torque.

In the present embodiment, the valve element 3 is covered by the cover 32. This can prevent deposits of the blowby gas from sticking to the valve element 3. Since the valve seat 32a is integrally formed with the cover 32, no additional valve seat is required to be formed. The number of parts or components constituting the PCV valve 31 can therefore be reduced.

### Fourth Embodiment

Next, a fourth embodiment of a PCV valve of the invention will be explained in detail referring to the accompanying drawings.

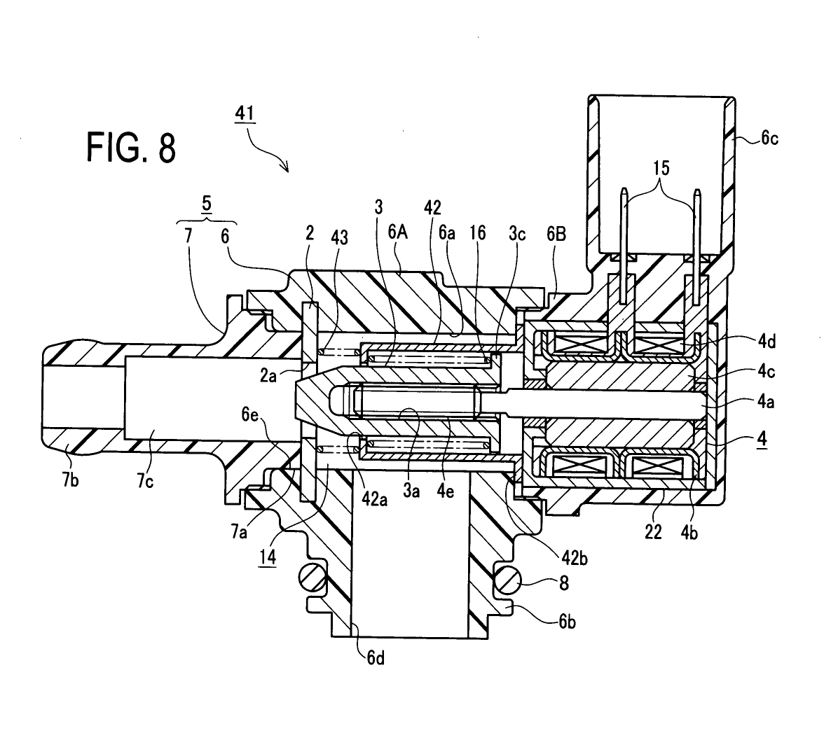

FIG. 8 is a sectional view of a PCV valve 41 of the fourth embodiment. The PCV valve 41 of the fourth embodiment differs in a cover 42 and associated parts thereof from the PCV valve 31 of the third embodiment. In this embodiment, specifically, the cover 42 is of a nearly cylindrical shape corresponding to the cover 32 of the third embodiment from which the valve seat 32a and the small-diameter portion 32b are removed. This cover 42 is also made of metal such as aluminum having a higher thermal conductivity than the main housing 6. The valve element 3 is placed to be movable through a distal open end 42a of the cover 42. Instead of the valve seat 32a, a separate valve seat 2 is insert-molded in the first main housing 6A as in the second embodiment. This valve seat 2 is made of metal such as aluminum. A distal end portion of the valve element 3 is insertable in the valve hole 2a of the valve seat 2. As above, the cover 42 having a higher thermal conductivity than the main housing 6 is placed in the blowby gas passage so as to cover the valve element 3. Further, a flange 42b formed at a proximal end of the cover 42 is placed in direct contact with the end surface of the motor case 22 of the step motor 4. This flange 42b is sandwiched and fixed between the end surface of the motor case 22 and the inner wall of the first main housing 6A. Further, a coil spring 43 serving as a metal elastic member of the invention is mounted between the valve seat 2 and the distal end of the cover 42. This coil spring 43 presses the cover 42 against the motor case 22.

According to the PCV valve 41 of this embodiment, accordingly, the heat generated in the step motor 4 is conducted from the motor case 22 to the cover 42 rapidly. The valve element 3 is thus heated rapidly by the heat released from the cover 42. Since the coil spring 43 is mounted between the valve seat 2 and the cover 42, the heat conducted from the step motor 4 to the cover 42 is also conducted to the valve seat 2 through the coil spring 43, thereby rapidly heating the valve seat 2. Moreover, the cover 42 is pressed against the step motor 4 (the motor case 22) by the coil spring 43, so that the contact strength between the cover 42 and the motor case 22 is enhanced and thus thermal conductivity between the cover member 42 and the motor case 22 is increased. Consequently, utilization of the heat generated in the step motor 4 can unfreeze the valve seat 2 and the valve element 3 without needing an additional special heating means such as electric heater.

In this embodiment, similar to the third embodiment, after warm-up where the freezing has been eliminated, the cover 42 can function as a radiator for the step motor 4. This can promote heat release of the step motor 4 to prevent the temperature of the step motor 4 from rising, thereby restraining a torque decrease. As compared with a case where the cover 42 is not used, the step motor 4 can be achieved in compact size for producing desired torque. In addition, it is possible to prevent deposits from sticking to part of the valve element 3 covered by the cover 43.

The present invention is not limited to the above embodiments and may be embodied in other specific forms without departing from the essential characteristics thereof.

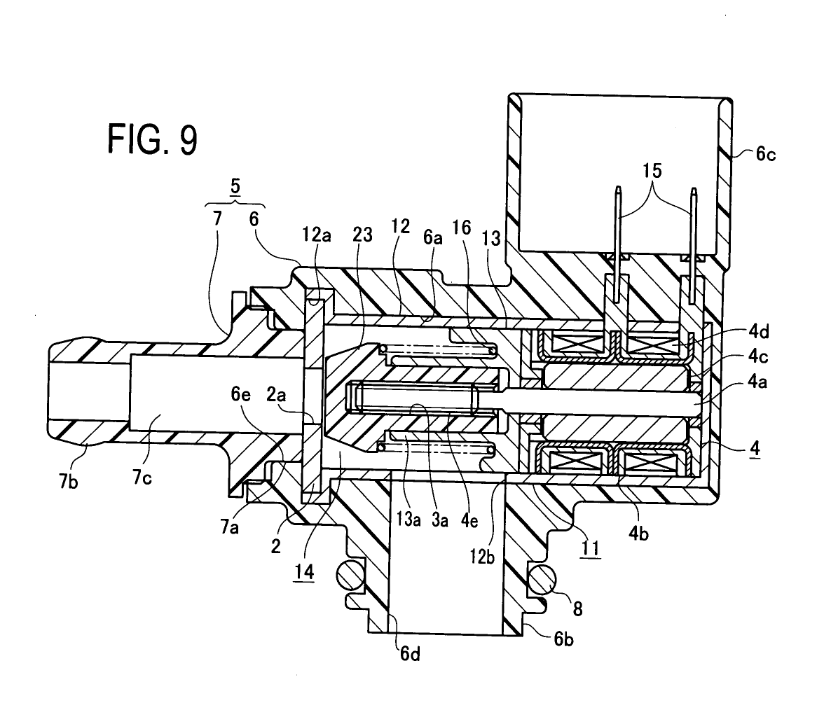

The first embodiment uses the valve element 3 of a nearly cylindrical shape having a round protruding distal end portion as shown in FIG. 1. As an alternative, as shown in FIG. 9, a poppet valve shaped like a mushroom having a flat end face may be used as a valve element 23 and other components or parts excepting this valve element 23 are identical to those in the first embodiment. In this case, the distal end face of the valve element 23 is configured to come into surface contact with the valve seat 2. It is accordingly possible to prevent deposits from becoming accumulated between the valve seat 2 and the valve element 23.

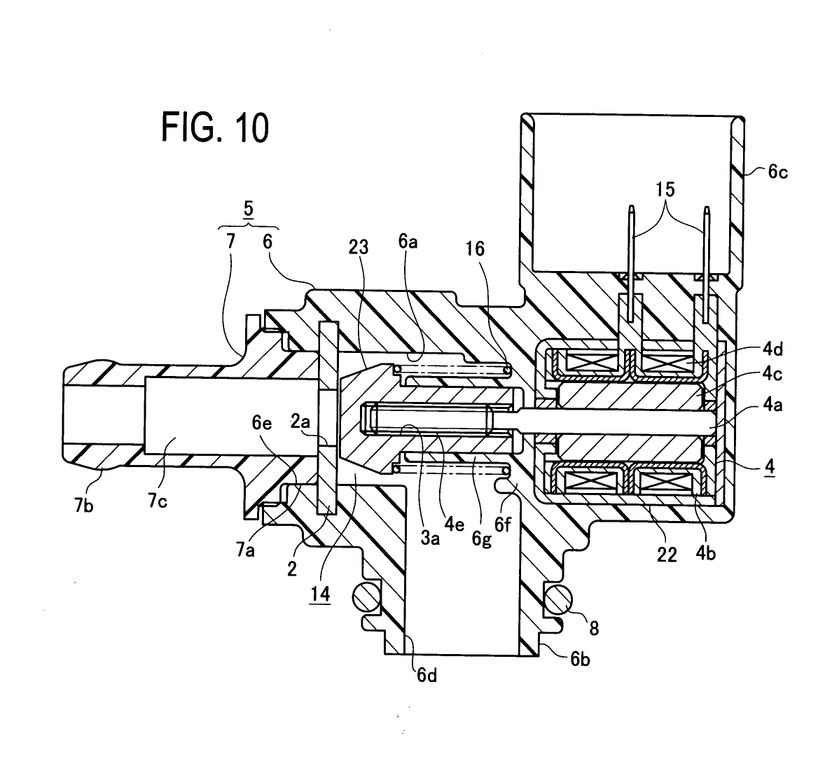

The second embodiment uses the valve element 3 of a nearly cylindrical shape having a round protruding distal end portion as shown in FIG. 4. As an alternative, as shown in FIG. 10, a poppet valve shaped like a mushroom having a flat end face may be used as a valve element 23 and other components or parts excepting this valve element 23 are identical to those in the first embodiment. In this case, the distal end face of the valve element 23 is configured to come into surface contact with the valve seat 2. It is accordingly possible to prevent deposits from becoming accumulated between the valve seat 2 and the valve element 23.

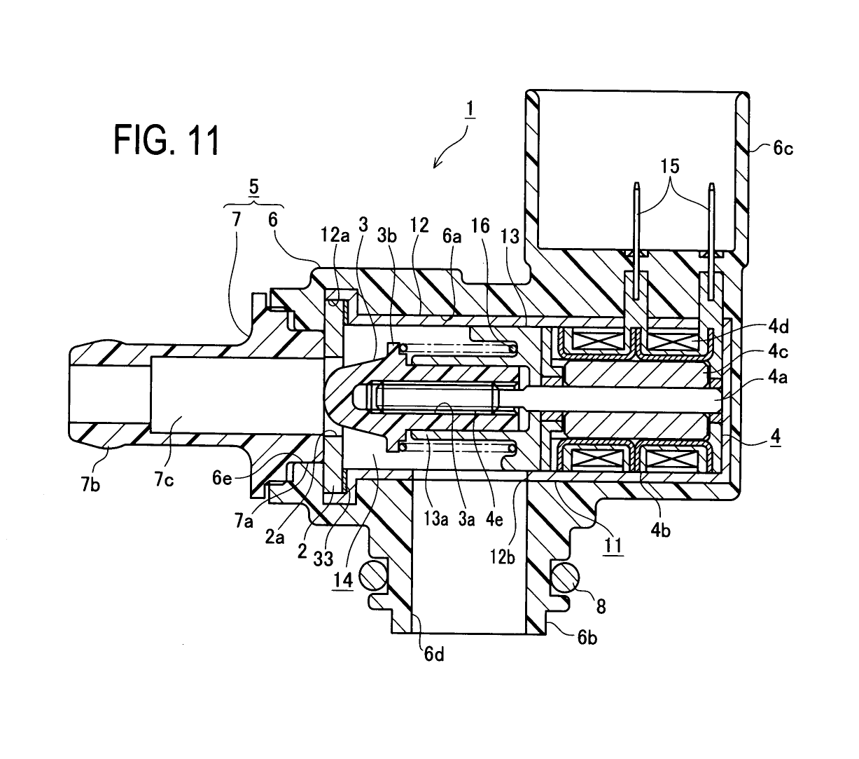

In the first embodiment, as shown in FIG. 1, the valve seat 2 is fitted in the opening 12a of the case 12. Alternatively, the graphite sheet 33 may be placed between the opening 12a of the case 12 and the valve seat 2 as shown in FIG. 11. This graphite sheet 33 can enhance heat conduction between the case 12 and the valve seat 2. This makes it possible to promote elimination of the freezing of the valve element 3 and the valve seat 2 and hence shorten the time required for the elimination of the freezing.

In the third embodiment, the graphite sheet 33 is placed between the flange 32c of the cover 32 and the end surface of the motor case 22 of the step motor 4. This graphite sheet 33 may be removed.

In the third embodiment, the graphite sheet 33 is provided as the heat conduction assist member of the invention. The heat conduction assist member may be a metal gasket or another member that is deformable to fill the clearance between components and assist heat conduction between the components.

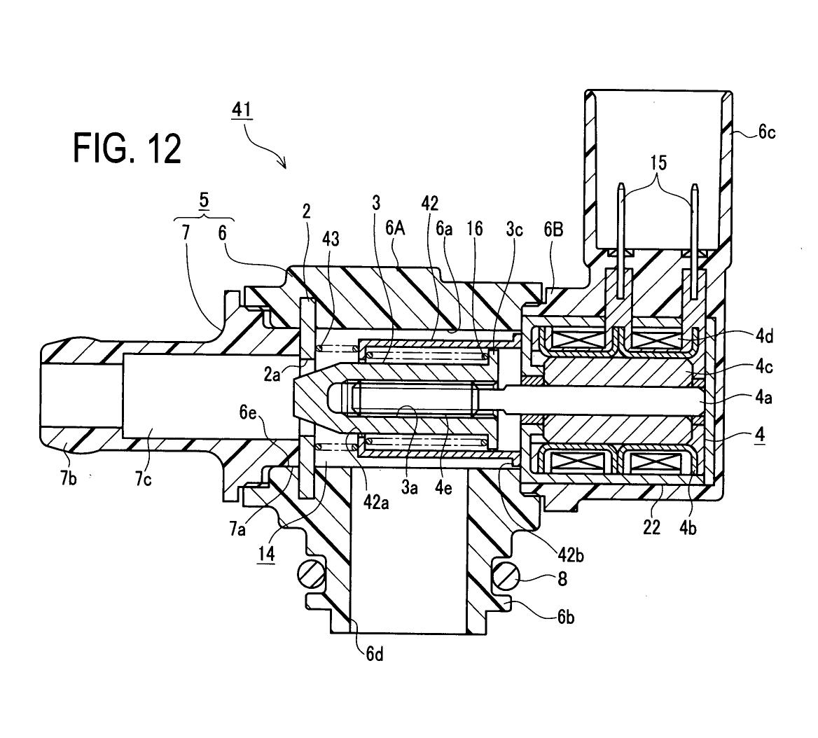

In the fourth embodiment, as shown in FIG. 5, the flange 42b of the cover 42 is fixedly held between the motor case 22 and the first main housing 6A. As an alternative, as shown in FIG. 12, the flange 42b of the cover 42 may be provided in contact with the motor case 22 instead of being held between the motor case 22 and the first main housing 6A. In this case, the cover 42 can be pressed against the motor case 22 by an urging force of the coil spring 43.

In the fourth embodiment, the flange 42b of the cover 42 is provided in direct contact with the motor case 22. Further, a graphite sheet may be provided between the flange 42b of the cover 42 and the motor case 22.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A PCV valve comprising:
a valve seat;
a valve element provided movable relative to the valve seat;
an electric device for moving the valve element; and
a housing which houses the valve seat, the valve element, and the electric device;
the PCV valve being arranged to operate the electric device by energization to move the valve element with respect to the valve seat so that an area of a blowby gas passage formed between the valve seat and the valve element is changed,
wherein the PCV valve includes a member having a higher thermal conductivity than the housing, and the member is placed in the housing to cover at least the electric device and the valve seat.

2. The PCV valve according to claim 1, wherein
the electric device and the valve seat are thermally connected to each other through the member having a higher thermal conductivity than the housing.

3. The PCV valve according to claim 1, wherein
the member having a higher thermal conductivity than the housing constitutes a wall surface of the blowby gas passage.

4. The PCV valve according to claim 2, wherein
the member having a higher thermal conductivity than the housing constitutes a wall surface of the blowby gas passage.

5. A PCV valve comprising:
a valve seat;
a valve element provided movable relative to the valve seat;
an electric device for moving the valve element; and
a housing which houses the valve seat, the valve element, and the electric device;
the PCV valve being arranged to operate the electric device by energization to move the valve element with respect to the valve seat so that an area of a blowby gas passage formed between the valve seat and the valve element is changed,
wherein the PCV valve includes a member having a higher thermal conductivity than the housing, and the electric device and at least one of the valve seat and the valve element are thermally connected to each other through the member having a higher thermal conductivity than the housing.

6. The PCV valve according to claim 5, wherein
at least one of the valve seat and the valve element is made of a material having a higher thermal conductivity than the housing.

7. The PCV valve according to claim 5, wherein
the electric device is a step motor including an output shaft, the member having a higher thermal conductivity than the housing is the output shaft, and the output shaft is thermally connected to the valve element.

8. The PCV valve according to claim 6, wherein
the electric device is a step motor including an output shaft, the member having a higher thermal conductivity than the housing is the output shaft, and the output shaft is thermally connected to the valve element.

9. A PCV valve comprising:
a valve seat;
a valve element provided movable relative to the valve seat;
an electric device for moving the valve element; and
a housing which houses the valve seat, the valve element, and the electric device;
the PCV valve being arranged to operate the electric device by energization to move the valve element with respect to the valve seat so that an area of a blowby gas passage formed between the valve seat and the valve element is changed,
wherein the PCV valve includes a cover having a higher thermal conductivity than the housing, the cover is placed in the blowby gas passage to cover the valve element, and one end of the cover is thermally connected to the electric device, and the valve seat is integrally formed with the cover.

10. The PCV valve according to claim 9 further comprising a heat conduction assist member between the electric device and the cover.

11. A PCV valve comprising:
a valve seat;
a valve element provided movable relative to the valve seat;
an electric device for moving the valve element; and
a housing which houses the valve seat, the valve element, and the electric device;
the PCV valve being arranged to operate the electric device by energization to move the valve element with respect to the valve seat so that an area of a blowby gas passage formed between the valve seat and the valve element is changed,
wherein the PCV valve includes a cover having a higher thermal conductivity than the housing, the cover is placed in the blowby gas passage to cover the valve element, and one end of the cover is thermally connected to the electric device,
the PCV valve further includes a metal elastic member mounted between the valve seat and the cover to press the cover against the electric device.

12. The PCV valve according to claim 11, wherein the metal elastic member is a coil spring.

13. The PCV valve according to claim 11 further comprising a heat conduction assist member between the electric device and the cover.

14. The PCV valve according to claim 1 further comprising a heat conduction assist member between the valve seat and the member having a higher thermal conductivity than the housing.

15. The PCV valve according to claim 5 further comprising a heat conduction assist member between the valve seat and the member having a higher thermal conductivity than the housing.
